(19) United States
(12) Patent Application Publication
(10) Pub. No.: US 2026/0331035 A1
(43) Pub. Date: Oct. 22, 2026

(54) PIXEL INCLUDING MICRO-LED, DISPLAY DEVICE INCLUDING PIXEL, AND ELECTRONIC DEVICE INCLUDING THE SAME

(71) Applicant: SAMSUNG ELECTRONICS CO., LTD., Suwon-si (KR)

(72) Inventors: Youngkil CHOI, Suwon-si (KR); Uijong SONG, Suwon-si (KR); Hyunwook LIM, Suwon-si (KR); Sunkwon KIM, Suwon-si (KR); Yongil KWON, Suwon-si (KR)

(73) Assignee: SAMSUNG ELECTRONICS CO., LTD., Suwon-si (KR)

(21) Appl. No.: 19/641,721

(22) Filed: Apr. 8, 2026

(30) Foreign Application Priority Data
Apr. 22, 2025 (KR) 10-2025-0052650
Oct. 1, 2025 (KR) 10-2025-0144180

(51) Int. Cl. G09G 3/32

(52) U.S. Cl. CPC G09G 3/32; G09G 2310/08

(57) ABSTRACT

A display device includes a pixel array having a plurality of pixels and a bias circuit configured to transmit a plurality of bias voltages to the pixels. Each pixel includes a micro-light emitting diode (LED), a driving circuit including at least one current source transistor configured to provide a driving current to the micro-LED based on the bias voltages, a control circuit including a plurality of memory devices configured to generate a pulse width modulation (PWM) signal, and a control transistor configured to supply a voltage to the driving circuit in response to the PWM signal. Separation of the control circuit and the current source transistor enables reduced high-voltage transistor usage and improved pixel integration.

### CROSS-REFERENCE TO RELATED APPLICATIONS

This application claims priority under 35 U.S.C. § 119 to Korean Patent Application Nos. 10-2025-0052650 filed on Apr. 22, 2025, and 10-2025-0144180 filed on Oct. 1, 2025, in the Korean Intellectual Property Office, the disclosures of which are incorporated herein by reference in their entireties.

### BACKGROUND

Embodiments of the present disclosure described herein relate to a pixel including a micro-light emitting diode (LED), a display device including the pixel, and an electronic device including the same.

Nowadays, a display device is being required to have a high resolution, low power consumption, and an improved image quality. Various display technologies are being developed to meet the requirements. Among the display technologies, a micro-LED technology is attracting attention for advantages such as high luminance, a fast response speed, and excellent reliability.

Various technical issues exist to finely integrate pixels at high resolution. For example, a highly integrated micro-LED pixel structure and a driving technology which are applicable to a small-sized display device such as augmented reality (AR) glasses are required.

### SUMMARY

Embodiments of the present disclosure provide a micro-LED pixel capable of improving the degree of integration of pixel driving elements, a display device including the micro-LED pixel, and an electronic device including the same.

According to an embodiment, a pixel may include a micro-LED that receives a driving current, a driving circuit that includes at least one current source transistor providing the driving current to the micro-LED based on a plurality of bias voltages, a control circuit that includes a plurality of memory devices and outputs a PWM signal, and a control transistor that provides a supply voltage to the driving circuit based on the PWM signal input to a gate terminal of the control transistor.

According to an embodiment, a display device may include a pixel array in which a plurality of pixels are arranged, and a bias circuit that transmits a plurality of bias voltages to each of the plurality of pixels. Each of the plurality of pixels may include a micro-light emitting diode (LED) that receives a driving current, a driving circuit that includes at least one current source transistor providing the driving current to the micro-LED based on the plurality of bias voltages, a control circuit that includes a plurality of memory devices and outputs a pulse width modulation (PWM) signal, and a control transistor that provides a supply voltage to the driving circuit based on the PWM signal input to a gate terminal of the control transistor.

According to an embodiment, an electronic device may include a display device that includes a pixel array in which a plurality of pixels are arranged, and a processor that transmits image data to the display device and controls the display device. Each of the plurality of pixels may include a micro-LED that receives a driving current, a driving circuit that includes at least one current source transistor providing the driving current to the micro-LED based on a plurality of bias voltages, a control circuit that includes a plurality of memory devices and outputs a pulse width modulation (PWM) signal, and a control transistor that provides a supply voltage to the driving circuit based on the PWM signal input to a gate terminal of the control transistor.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a display device according to one or more embodiments of the present disclosure.

FIG. 2 is a diagram describing a pixel according to one or more embodiments of the present disclosure.

FIG. 3 is a diagram describing a pixel according to an embodiment of available alternative technologies.

FIG. 4 is a diagram describing a control circuit of a pixel according to one or more embodiments of the present disclosure.

FIG. 5 is a timing diagram for describing an operation of a pixel according to one or more embodiments of the present disclosure.

FIG. 6 is a diagram describing a driving circuit of a pixel according to one or more embodiments of the present disclosure.

FIG. 7 is a diagram describing a bias circuit according to one or more embodiments of the present disclosure.

FIG. 8 is a diagram describing a driving circuit of a pixel according to one or more embodiments of the present disclosure.

FIG. 9 is a diagram describing a selection circuit of a driving circuit according to the embodiment of FIG. 8.

FIG. 10 is a diagram describing a bias circuit according to one or more embodiments of the present disclosure.

FIG. 11 is a block diagram describing a configuration of an electronic device according to one or more embodiments of the present disclosure.

FIG. 12 is a diagram describing a display device according to one or more embodiments of the present disclosure.

### DETAILED DESCRIPTION

Below, embodiments of the present disclosure will be described in detail and clearly to such an extent that an ordinary one in the art easily carries out the present disclosure.

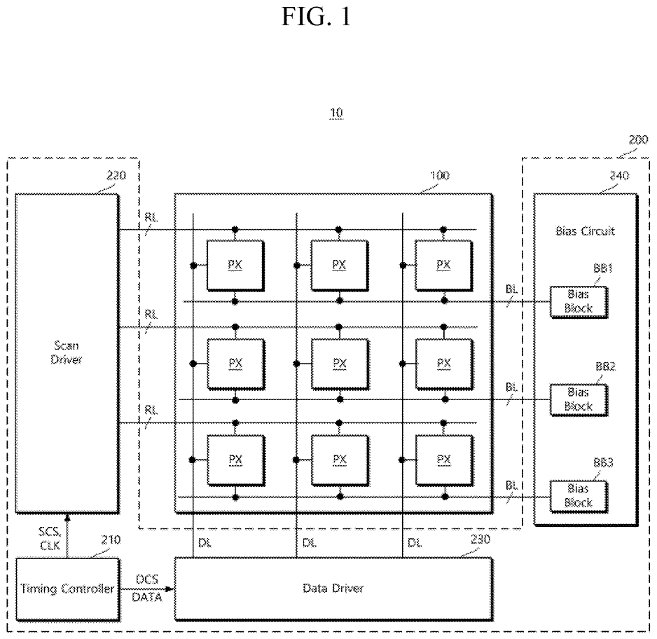

FIG. 1 is a block diagram illustrating a display device according to one or more embodiments of the present disclosure.

Referring to FIG. 1, a display device 10 may include a pixel array 100 and a pixel driving unit 200.

The pixel array 100 may display an image in response to a data signal received from a data driver 230 through a data line DL and a scan signal received from a scan driver 220 through a row line RL.

The pixel array 100 may include a plurality of pixels PX connected to row lines RL and data lines DL. In an embodiment, FIG. 1 shows nine pixels PX, but the display device 10 according to an embodiment of the present disclosure is not limited thereto. For example, the display device 10 according to an embodiment of the present disclosure may include pixels PX, the number of which is less than or more than 9.

The pixels PX may be selected in units of horizontal line in response to a scan signal supplied to any one of the row lines RL. Each of the pixels PX selected by the scan signal may receive the data signal from the data line DL connected thereto. Each of the pixels PX receiving the data signal may emit a light with a given luminance corresponding to the data signal. The data signal may be an n-bit digital image signal capable of displaying 1 to scales. Each of the pixels PX may emit a light having a single color. For example, each of the pixels PX may output a light signal having one of a red color, a blue color, a green color, and a white color. Each of the pixels PX may output a light signal having a color different from the above colors.

The pixels PX may be located in the pixel array 100 in a preset pattern, for example, in various patterns such as a diamond pattern, a matrix pattern, and a zigzag pattern.

Each of the pixels PX may include a light emitting element. The light emitting element may be an LED, and for example, the light emitting element may be a micro-LED. The light emitting element may be an LED whose unit is several microns or tens of microns. Alternatively, the light emitting element may be a nano-sized LED. The light emitting element may emit a light of a single peak wavelength or may emit a light having a plurality of peak wavelengths. The light emitting element may be controlled based on a pulse width modulation (PWM) signal.

Each of the pixels PX may further include a pixel circuit connected to the light emitting element. The pixel circuit may include at least one transistor and/or at least one memory device. The pixel circuit may be implemented on a substrate in a semiconductor-stacked structure. For example, a substrate where the light emitting element is located and a substrate where the pixel circuit is located may be different substrates.

The pixel driving unit 200 may drive and control the pixel array 100. The pixel driving unit 200 may include a timing controller 210, the scan driver 220, the data driver 230, and a bias circuit 240. The data driver 230 may drive the pixel array 100 in units of column. The scan driver 220 may drive the pixel array 100 in units of row.

The timing controller 210 may receive image data, synchronization signals and a clock signal for controlling the display of the image data, etc. The timing controller 210 may correct the image data received from the outside so as to be appropriate for the image display of the pixel array 100 and may transmit corrected image data “DATA” to the data driver 230.

The timing controller 210 may output a data control signal DCS for controlling the operation timing of the data driver 230 and a scan control signal SCS for controlling the operation timing of the scan driver 220.

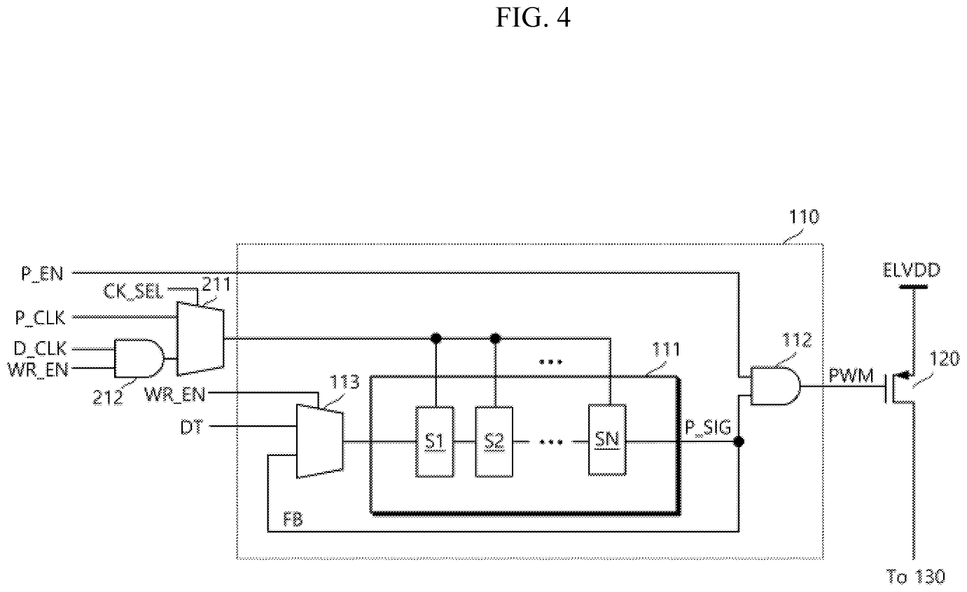

In an embodiment, the timing controller 210 may generate clock signals CLK to be provided to the pixel PX and may provide the clock signals CLK to the scan driver 220. For example, the timing controller 210 may generate a data clock D_CLK to be used for the pixel PX to receive and store data and a PWM clock P_CLK for outputting the stored data as a PWM signal, which will be described with reference to FIG. 4.

The scan driver 220 may transmit the scan signal sequentially to the row lines RL in response to the scan control signal SCS of the timing controller 210. The pixels PX electrically connected to each of the row lines RL may be selected in response to the scan signal.

The scan driver 220 may generate clock signals and control signals for driving and controlling the pixel array 100. The control signals for driving and controlling the pixel array 100 may include an enable signal. For example, the control signals may include a write enable signal W_EN for activating the writing of data in a memory device of the pixel PX, a clock selection signal C_SEL for selecting a clock signal to be input to the pixel PX, a PWM enable signal P_EN for activating the PWM signal, etc. The control signals may be transmitted to the pixel array 100 by using the row lines RL.

The data driver 230 may be electrically connected to the pixels PX through a plurality of data lines DL and may transmit a data signal to the pixel array 100 through the data lines DL. The data driver 230 may generate a data signal (or a data voltage) in response to the data control signal DCS and may transmit the generated data signal to the pixel array 100 through the data lines DL during a horizontal period. The data driver 230 may receive a frame of image data from an external device (e.g., a graphic processing unit), may extract a grayscale from the received image data for each pixel PX, and may convert the extracted grayscale into digital data including bits, the number of which is determined in advance.

The data driver 230 may transmit the converted digital data to each of the pixels PX in units of column. In an embodiment, the data driver 230 may transmit the digital data to each pixel PX in preset order from the most significant bit (hereinafter referred to as an “MSB”) to the least significant bit (hereinafter referred to as an “LSB”). The data driver 230 may transmit a bit value of the digital data to each pixel PX for each frame.

The bias circuit 240 may transmit a plurality of bias voltages to each of the pixels PX through bias lines BL. A current source transistor of each of the pixels PX may provide a driving current to the light emitting element based on the plurality of bias voltages.

In an embodiment, the bias circuit 240 may include a plurality of bias blocks BB1, BB2, and BB3. Each of the plurality of bias blocks BB1, BB2, and BB3 may provide the plurality of bias voltages to pixels of the pixel array 100, which are located at the corresponding row. For example, a first pixel and a second pixel located at a first row may receive the plurality of bias voltages through the same lines from the first bias block BB1 corresponding to the first row.

The components of the pixel driving unit 200 may be implemented in the form of an independent integrated circuit chip or in the form of a single integrated circuit chip. The components of the pixel driving unit 200 may be implemented together on a substrate where the pixel array 100 is located; alternatively, the components of the pixel driving unit 200 may be implemented in an independent integrated circuit chip and then may be electrically connected to the substrate where the pixel array 100 is located. According to an embodiment, some of the components of the pixel driving unit 200 may be implemented together on the substrate where the pixel array 100 is located, and the others thereof may be implemented in an integrated circuit chip independent of the substrate where the pixel array 100 is located.

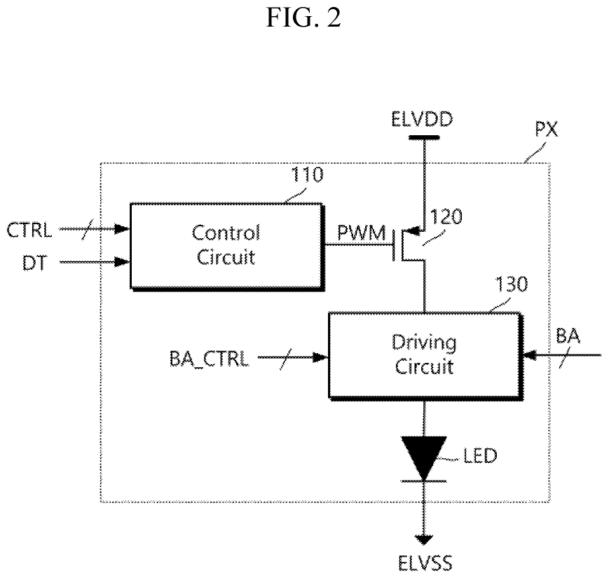

Each of the pixels PX according to one or more embodiments of the present disclosure may include a driving circuit which outputs the driving current based on bias voltages received from a bias circuit located outside the pixel; in each of the pixels PX, a control circuit which outputs the PWM signal may be separated from the light emitting element. Through the above structure of the pixel circuit, the number of transistors of the pixel PX, which require a high operating voltage, may decrease or may not increase. Accordingly, even though the number of transistors of the pixel PX increases, the active area of the pixel PX may decrease or may not increase. This will be described in detail with reference to FIG. 2.

FIG. 2 is a diagram describing the pixel PX according to one or more embodiments of the present disclosure.

A display device according to one or more embodiments of the present disclosure may include the pixel PX including a micro-LED. In each of the pixels PX, a control circuit 110 which outputs the PWM signal for controlling light emission may be electrically connected to a micro-LED LED through a driving circuit 130 including a current source transistor. The pixel PX according to one or more embodiments of the present disclosure will be described in detail with reference to FIG. 2.

Referring to FIG. 2, the pixel PX according to one or more embodiments of the present disclosure may include the control circuit 110, a control transistor 120, the driving circuit 130, and the micro-LED LED.

The micro-LED LED may receive the driving current from the driving circuit 130. The micro-LED LED may emit a light based on the received driving current.

The driving circuit 130 may electrically connect the control transistor 120 to the micro-LED LED. The driving circuit 130 may provide the driving current to the micro-LED LED.

The driving circuit 130 may determine the substantial magnitude of the driving current to be provided to the micro-LED LED. The driving circuit 130 may output the driving current based on a plurality of bias voltages BA. The driving circuit 130 may output the driving current, which is based on at least one of the plurality of bias voltages BA, in response to a bias control signal BA_CTRL.

For example, the driving circuit 130 may include at least one current source transistor configured to output the driving current based on at least one of the plurality of bias voltages BA.

The control transistor 120 may receive a PWM signal PWM from the control circuit 110. The control transistor 120 may provide a supply voltage ELVDD to the driving circuit 130 based on the PWM signal PWM input to a gate node from the control circuit 110.

For example, when the PWM signal PWM is at a first level indicating activation, the control transistor 120 may be turned on and may transmit the supply voltage ELVDD to the driving circuit 130, and the driving circuit 130 may output the driving current based on the supply voltage ELVDD. The micro-LED LED may emit a light based on the received driving current. When the PWM signal PWM is at a second level indicating deactivation, the control transistor 120 may be turned off and may not transmit the supply voltage ELVDD to the driving circuit 130, and the driving circuit 130 may not output the driving current. As a result, the micro-LED LED may not emit a light. An emission time of the micro-LED LED may be controlled depending on a turn-on time and a turn-off time of the control transistor 120.

The control circuit 110 may include a plurality of memory devices, and the plurality of memory devices may store data. The data may be, for example, a signal which is obtained by performing pulse width modulation on a grayscale extracted from the image data. The plurality of memory devices may include any one of a latch, a flip-flop, and a static random access memory (SRAM). For example, the plurality of memory devices may include a plurality of SRAM elements connected in series.

In each of the pixels PX according to one or more embodiments of the present disclosure, the driving circuit 130 which outputs the driving current based on the bias voltages BA received from the bias circuit located outside the pixel PX may separate, from the micro-LED LED, the control transistor 120 providing the supply voltage ELVDD based on the PWM signal PWM and the control circuit 110 outputting the PWM signal PWM.

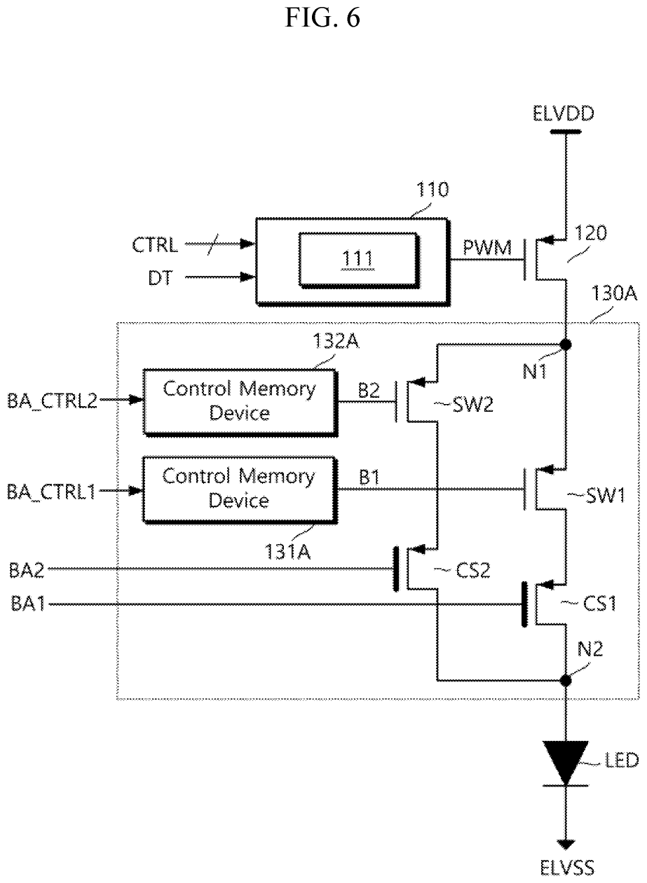

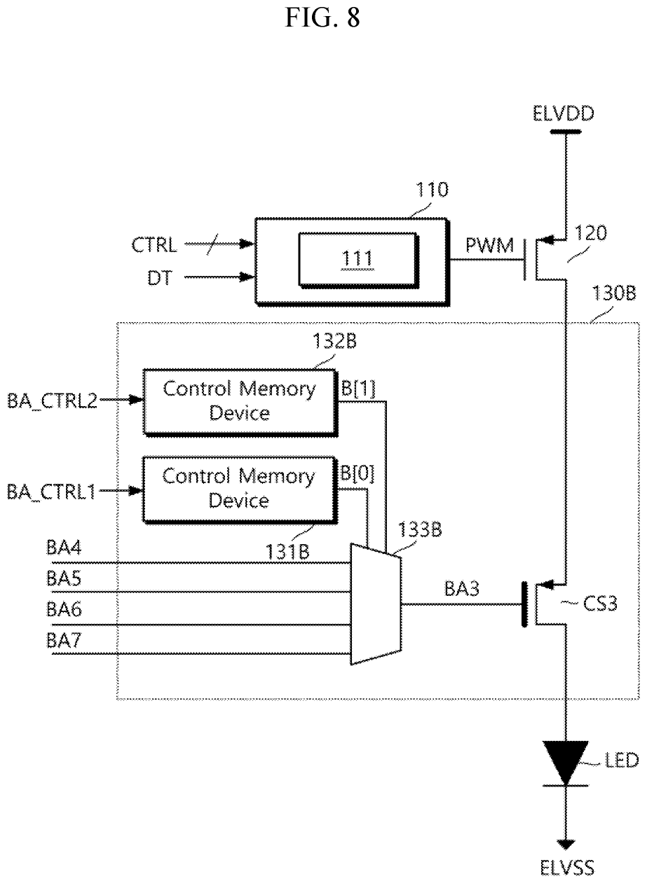

Accordingly, only the current source transistor of the driving circuit 130, which is directly connected to the micro-LED LED, may require a high operating voltage, and the remaining elements other than the current source transistor may operate at a low operating voltage. This will be described in detail with reference to FIGS. 6 and 8.

Also, the transistor of the control circuit 110 and/or the control transistor 120 separated from the micro-LED LED by the driving circuit 130 may operate at a low operating voltage. A transistor configured to operate at a second operating voltage higher than a first operating voltage requires the larger active area than a transistor configured to operate at the first operating voltage. For example, the channel length of the transistor configured to operate at the second operating voltage may be longer than the channel length of the transistor configured to operate at the first operating voltage.

The pixel PX according to one or more embodiments of the present disclosure does not include a large number of transistors which require a high operating voltage. Accordingly, due to transistors requiring a high operating voltage, the pixel PX may decrease the active area or may not increase the active area. The active area which is secured by the decrease in the number of transistors requiring a high operating voltage may be used for a plurality of memory devices of the control circuit 110. The plurality of memory devices may store data of a plurality of sub-frames.

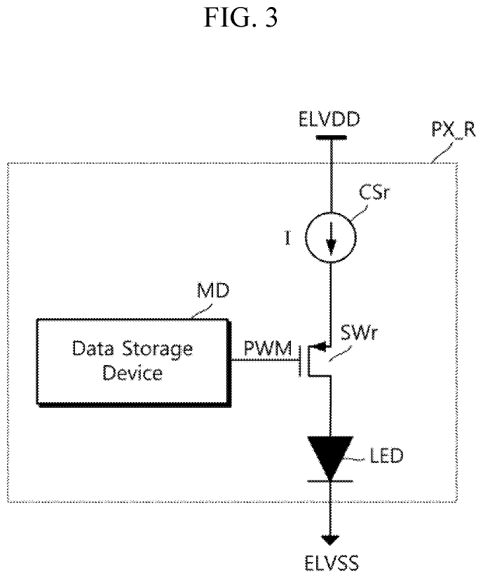

FIG. 3 is a diagram describing a pixel PX_R according to an embodiment of available alternative technologies.

Referring to FIG. 3, a transistor SWr which receives the PWM signal PWM output from a data storage device MD connects the micro-LED LED with a constant current source CSr providing the driving current.

Due to a high forward voltage of the micro-LED LED, each of the transistor SWr and the data storage device MD outputting the PWM signal PWM for driving the transistor SWr requires a high operating voltage for the stable operation of the pixel PX_R. This means that the pixel PX_R including a plurality of transistors operating at a high operating voltage requires the large active area. Due to the plurality of transistors operating at a high operating voltage, it is difficult to reduce the size of the pixel PX_R, and it is difficult to implement a high-definition display device with the small area.

FIG. 4 is a diagram describing the control circuit 110 of a pixel according to one or more embodiments of the present disclosure. The control circuit 110 of FIG. 4 may correspond to the control circuit 110 of FIG. 2.

Referring to FIG. 4, the control circuit 110 may include a plurality of memory devices 111, a pixel gate element 112, and a write selection circuit 113. The driving circuit 130 may be electrically connected to a clock selection circuit 211, and the plurality of memory devices 111 may store and output bits included in data DT received from the data driver 230 of FIG. 1 through the data line DL.

In an embodiment, the plurality of memory devices 111 may store MSB to LSB values of the data DT sequentially in order from the MSB to the LSB or in order from the LSB to the MSB. Alternatively, the plurality of memory devices 111 may respectively store bits corresponding to the sub-frame of the data DT depending on a preset order. Unlike the illustration of FIG. 4, the plurality of memory devices 111 may receive or output the data DT in parallel.

The data DT may be input to the plurality of memory devices 111 through the write selection circuit 113. The write selection circuit 113 may be provided with the data DT and data stored in the last memory device SN among the plurality of memory devices 111 as feedback data FB. The write selection circuit 113 may output one of the received data DT and the received feedback data FB based on the write enable signal WR_EN.

The plurality of memory devices 111 may receive a clock signal from the clock selection circuit 211 located outside the pixel PX. The clock selection circuit 211 may receive an output of a row gate element 212 and the PWM clock P_CLK. The row gate element 212 may receive the write enable signal W_EN and the data clock D_CLK, and the clock selection circuit 211 may output one of the output of the row gate element 212 and the PWM clock P_CLK based on the clock selection signal C_SEL.

In each of the plurality of memory devices 111, the memory devices S1, S2, . . . , SN may store the data DT based on the data clock D_CLK. The plurality of memory devices 111 may output a PWM signal P_SIG based on the PWM clock P_CLK. The PWM clock P_CLK may toggle every sub-frame included in a frame during one frame. In response to the clock signal received from the clock selection circuit 211, the memory devices S1, S2, . . . , SN of each of the plurality of memory devices 111 may store the data DT or the feedback data FB or may output the PWM signal P_SIG. The plurality of memory devices 111 may store a bit value of the data DT during a data write period and may output the PWM signal P_SIG based on the stored bit value and the PWM signal P_SIG during an emission period.

The PWM signal P_SIG output from the plurality of memory devices 111 may be input to the pixel gate element 112. The pixel gate element 112 may output the PWM signal P_SIG based on the PWM enable signal P_EN.

Unlike the description given with reference to FIG. 4, the driving circuit 130 may be implemented with any other circuit structure. For example, data stored in a memory device located immediately before the last memory device SN may be used as the feedback data FB. In this case, a connection relationship of elements providing clock signals may be changed. That is, a driving circuit of a pixel according to one or more embodiments of the present disclosure may include a plurality of memory devices, and the plurality of memory devices may be implemented with various structures in which a bit value of data is stored during a data write period and a PWM signal is output based on the stored bit value during an emission period.

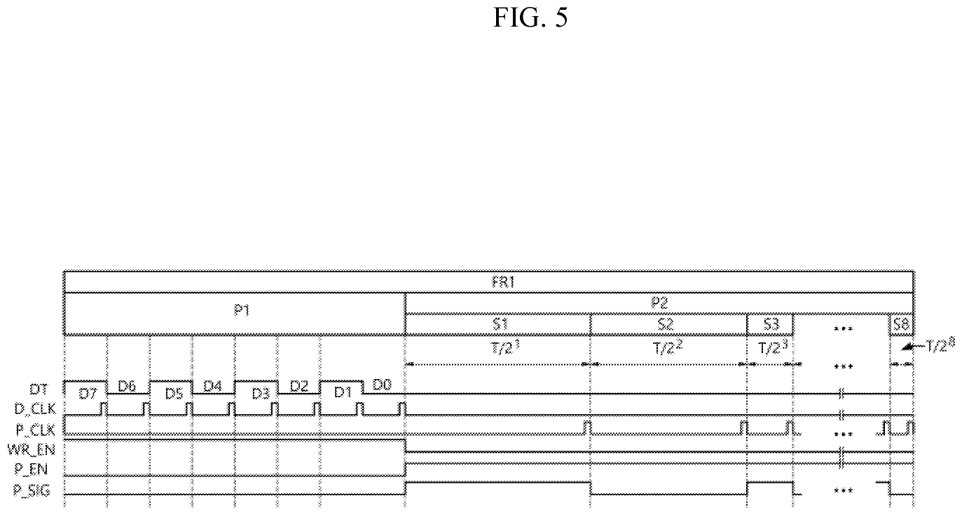

FIG. 5 is a timing diagram for describing an operation of a pixel according to one or more embodiments of the present disclosure. FIG. 5 is a timing diagram for displaying data which the pixel PX of the display device 10 of FIG. 1 displays based on one frame.

One frame may include a plurality of sub-frames. When the display device 10 displays n-bit image data, one frame may include ‘n’ sub-frames. Each of the ‘n’ sub-frames may correspond to each bit of the n-bit image data. The sub-frames may have different periods. For example, the period of the sub-frame corresponding to the MSB of the digital data may be set to be the longest, and the period of the sub-frame corresponding to the LSB of the digital data may be set to be the shortest. The order from the MSB to the LSB of the digital data may correspond to the order from the first sub-frame to the n-th sub-frame, but the order of sub-frames may be variously set.

Referring to FIG. 5, one frame period FR1 may include a data write period P1 and an emission period P2. A first period “T” may mean a time length of the emission period P2. The emission period P2 may include a plurality of sub-frames S1 to S8. The plurality of sub-frames S1 to S8 may have different periods.

During the data write period P1, in the pixel PX of FIG. 1, a bit value of data D0 to D7 may be stored in the plurality of memory devices 111 of FIG. 4 based on the write enable signal WR_EN and the data clock D_CLK. For convenience of description, FIG. 5 shows an example in which the bit value of the data D0 to D7 is “10101010”, but the bit value of the data D0 to D7 may be differently set based on image data.

During the emission period P2, the plurality of memory devices 111 of FIG. 4 may output the PWM signal P_SIG based on the PWM clock P_CLK and the data D0 to D7. For example, the plurality of memory devices 111 may output the PWM signal, whose level is activated during the sub-frame corresponding to each bit, based on a data bit having a value of “1”. During the emission period P2, the PWM clock P_CLK may toggle every sub-frame.

For convenience of description, for example, the PWM signal P_SIG of FIG. 5 is illustrated as a PWM signal which is based on the data D0 to D7 having the bit value of “10101010”, but the PWM signal P_SIG may be differently set based on the bit value of the data D0 to D7.

FIG. 6 is a diagram describing a driving circuit 130A of a pixel according to one or more embodiments of the present disclosure. The driving circuit 130A of FIG. 6 may correspond to the driving circuit 130 of FIG. 2.

Referring to FIG. 6, the driving circuit 130A may be configured to provide at least one of a plurality of driving currents to the micro-LED LED.

The driving circuit 130A may include a plurality of current paths between nodes N1 and N2 between the control transistor 120 and the micro-LED LED. FIG. 6 shows two current paths as an example, but the driving circuit according to an embodiment of the present disclosure may include three or more current paths.

Each of the plurality of current paths may include a switch and a current source transistor connecting one end of the switch and the micro-LED LED.

For example, referring to FIG. 6, a first current path may include a first switch SW1 and a first current source transistor CS1 connected between the first node N1 and the second node N2. A second current path may include a second switch SW2 and a second current source transistor CS2 connected between the first node N1 and the second node N2. The first node N1 may be connected to one end of the control transistor 120, and the second node N2 may be connected to an anode of the micro-LED LED.

The first current source transistor CS1 may connect the first switch SW1 and the micro-LED LED, and the second current source transistor CS2 may connect the second switch SW2 and the micro-LED LED. The first current source transistor CS1 may receive a first bias voltage BA1 through a gate terminal thereof, and the second current source transistor CS2 may receive a second bias voltage BA2 through a gate terminal thereof. The first current source transistor CS1 and the second current source transistor CS2 may provide the first bias voltage BA1 and the second bias voltage BA2 to the micro-LED LED through the second node N2 based on the first bias voltage BA1 and the second bias voltage BA2.

In an embodiment, the magnitude of the first bias voltage BA1 may be the same as the magnitude of the second bias voltage BA2, or the magnitude of the first bias voltage BA1 may be different from the magnitude of the second bias voltage BA2. The magnitude of the first driving current may be determined based on the first bias voltage BA1, and the magnitude of the second driving current may be determined based on the second bias voltage BA2. Accordingly, the magnitude of the first driving current may be the same as the magnitude of the second driving current, or the magnitude of the first driving current may be different from the magnitude of the second driving current.

The first switch SW1 may connect the control transistor 120 and the first current source transistor CS1, and the second switch SW2 may connect the control transistor 120 to the second current source transistor CS2. The first switch SW1 may be controlled by a first control memory device 131A, and the second switch SW2 may be controlled by a second control memory device 132A.

For example, referring to FIG. 6, each of the first control memory device 131A and the second control memory device 132A may include a memory device which stores at least one bit. The memory device of each of the first control memory device 131A and the second control memory device 132A may include any one of a latch, a flip-flop, and an SRAM. The first control memory device 131A may receive a first bias control signal BA_CTRL1 and may store the received first bias control signal BA_CTRL1 in the memory device, and the second control memory device 132A may receive a second bias control signal BA_CTRL2 and may store the received second bias control signal BA_CTRL2 in the memory device. The first control memory device 131A may output a bias control signal B1 to a gate node of the first switch SW1 based on the stored bias control signal BA_CTRL1, and the second control memory device 132A may output a bias control signal B2 to a gate node of the second switch SW2 based on the stored bias control signal BA_CTRL2.

The first current path may be activated by the first bias control signal BA_CTRL1, and the second current path may be activated by the second bias control signal BA_CTRL2. The first driving current and the second driving current may be provided to the micro-LED LED through the first current path and the second current path based on the PWM signal PWM.

In an embodiment, the first current path and the second current path may be selectively activated based on the first bias control signal BA_CTRL1 and the second bias control signal BA_CTRL2, or both the first current path and the second current path may be activated based on the first bias control signal BA_CTRL1 and the second bias control signal BA_CTRL2. For example, the first bias control signal BA_CTRL1 and the second bias control signal BA_CTRL2 may be configured to turn on both the first switch SW1 and the second switch SW2 or to turn on any one of the first switch SW1 and the second switch SW2.

Accordingly, the first driving current may be provided to the micro-LED LED through the first current path, the second driving current may be provided to the micro-LED LED through the second current path, or both the first driving current and the second driving current may be provided to the micro-LED LED through the first current path and the second current path. That is, the magnitude of the driving current to be provided to the micro-LED LED may be adjusted (or controlled) by controlling the first switch SW1 and the second switch SW2.

The display device may decrease the emission non-uniformity of the micro-LED LED, which is caused by the distribution of the micro-LEDs LED of the pixels PX and/or the distribution of the driving circuits of the pixels PX, by using the first bias control signal BA_CTRL1 and the second bias control signal BA_CTRL2. Accordingly, the display device may decrease at least a portion of the emission non-uniformity of the micro-LED LED by using the first control memory device 131A and the second control memory device 132A which have a small storage capacity and belong to each of the pixels PX.

To decrease the emission non-uniformity of the micro-LED LED, a control memory device which is used to activate a plurality of current paths may be implemented with a plurality of transistors. When the display device is implemented as a component of the very small form factor (e.g., AR class) and a high-definition display device is required, it is essential to secure the active area in which a control memory device of pixels of the display device will be implemented.

As a control memory device of a pixel according to an embodiment of the present disclosure controls a switch independent of a current source transistor connected to the micro-LED, the control memory device may be implemented with transistors operating at a low operating voltage.

That is, as the remaining components of the pixel driving circuit are separated from the micro-LED by using the current source transistors CS1 and CS2, only the current source transistors CS1 and CS2 may be implemented by using a transistor operating at a high operating voltage, and the remaining components other than the current source transistors CS1 and CS2 may be implemented by using a transistor operating at a low operating voltage. In the driving circuit 130A, the remaining components other than the current source transistors CS1 and CS2 providing the driving current to the micro-LED LED, for example, transistors constituting the switches SW1 and SW2 and the control memory devices 131A and 132A controlling the switches SW1 and SW2 may also operate at a low operating voltage.

Also, as described with reference to FIGS. 2 and 4, the plurality of memory devices of the control circuit 110 may also be implemented by using transistors operating at a low operating voltage. That is, as the remaining components of the pixel driving circuit are separated from the micro-LED by using a current source transistor, only the current source transistor may be implemented by using a transistor operating at a high operating voltage, and the remaining components other than the current source transistor may be implemented by using a transistor operating at a low operating voltage. As a result, the active area for implementing various memory devices of a pixel may be secured, and even though memory devices are provided for each pixel, a display device of a high resolution may be implemented by using the small area.

In addition, a bias voltage which provides a plurality of bias voltages to the current source transistor may be located outside the pixel, and thus, a display device of a high resolution may be implemented by using the small area.

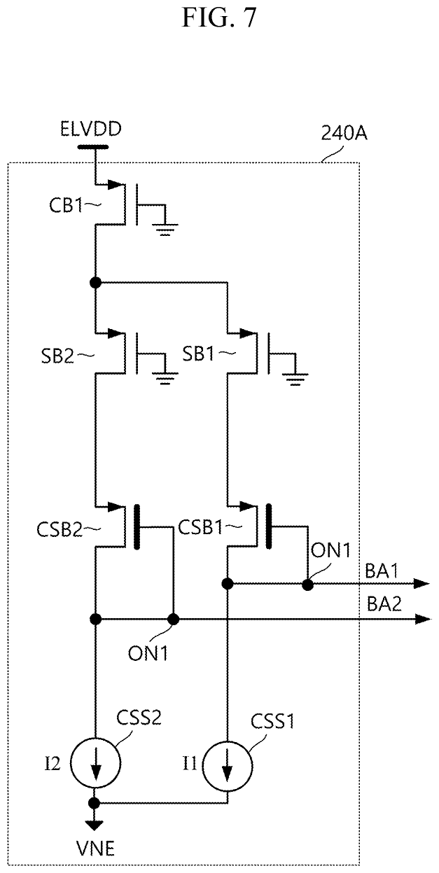

FIG. 7 is a diagram describing a bias circuit according to one or more embodiments of the present disclosure. A bias circuit of FIG. 7 may correspond to the bias circuit 240 of FIG. 1.

Referring to FIG. 7, a bias circuit 240A may include a plurality of bias transistors CSB1 and CSB2. In the bias transistor CSB1, any one of a source terminal and a drain terminal may be connected to a gate terminal, and the gate terminal may be connected to a bias voltage output node ON1; in the bias transistor CSB2, any one of a source terminal and a drain terminal may be connected to a gate terminal, and the gate terminal may be connected to a bias voltage output node ON2. The plurality of bias transistors CSB1 and CSB2 may output the bias voltages BA1 and BA2 through the bias voltage output nodes ON1 and ON2, respectively.

In the bias transistor CSB1, any one of the source terminal and the drain terminal may be connected to a constant current source CSS1, and the other thereof may be connected to a first transistor SB1; in the bias transistor CSB2, any one of the source terminal and the drain terminal may be connected to a constant current source CSS2, and the other thereof may be connected to a second transistor SB2. Each of the first transistor SB1 and the second transistor SB2 may receive the supply voltage ELVDD through a transistor CB1.

The bias circuit 240A of FIG. 7 may constitute a current mirror circuit with the current source transistors CS1 and CS2, the switches SW1 and SW2, and the control transistor 120 of the pixel driving circuit 130A of FIG. 6. Each transistor of the bias circuit 240A may operate as a reference transistor, and each of the current source transistors CS1 and CS2, the switches SW1 and SW2, and the control transistor 120 of the pixel driving circuit 130A of FIG. 6 may operate as a mirror transistor.

For example, the transistor CB1 of the bias circuit 240A may have the same aspect ratio as the control transistor 120. Each of the first transistor SB1 and the second transistor SB2 may have the same aspect ratio as each of the first switch SW1 and the second switch SW2. Each of the plurality of bias transistors CSB1 and CSB2 may have the same aspect ratio as each of the current source transistors CS1 and CS2. Each of the plurality of bias transistors CSB1 and CSB2 may be configured to operate at a high operating voltage.

The bias circuit 240A which provides a plurality of bias voltages may be implemented to constitute a current mirror outside a pixel and supplies the plurality of bias voltages to the pixel. Accordingly, a display device of a high resolution may be implemented by using the small area.

FIG. 8 is a diagram describing a driving circuit 130B of a pixel according to one or more embodiments of the present disclosure. The driving circuit 130B of FIG. 8 may correspond to the driving circuit 130 of FIG. 2. The description which is the same as the description given based on the embodiment of FIG. 6 will be omitted to avoid redundancy. A difference between the embodiment of FIG. 6 and the embodiment of FIG. 8 will be mainly described.

Referring to FIG. 8, the driving circuit 130B may be configured to control the magnitude of the driving current which is provided to the micro-LED LED.

Referring to FIG. 8A, unlike the embodiment of FIG. 6, the driving circuit 130B may include only one current path. A current source transistor CS3 of a current path may connect the control circuit 110 and the micro-LED LED. The current source transistor CS3 may receive a bias voltage BA3 which a selection circuit 133B outputs to a gate terminal of the current source transistor CS3. The current source transistor CS3 may be controlled by the bias voltage BA3 such that the magnitude of the driving current is adjusted.

The selection circuit 133B may receive a plurality of bias voltages BA4, BA5, BA6, and BA7. Four bias voltages BA4, BA5, BA6, and BA7 are illustrated in FIG. 8 as an example, but the selection circuit 133B may receive three or fewer bias voltages or four or more bias voltages.

Referring to FIG. 8, the selection circuit 133B may select one of the bias voltages BA4, BA5, BA6, and BA7 based on bias control signals B[0] and B[1]. The selection circuit 133B may include a multiplexer. The selected bias voltage may be provided to the current source transistor CS3.

A control memory device 131B may store the first bias control signal BA_CTRL1 and may output the bias control signal B[0], and a control memory device 132B may store the second bias control signal BA_CTRL2 and may output the bias control signal B[1].

The bias voltages BA4, BA5, BA6, and BA7 input to the selection circuit 133B may have different magnitudes. Accordingly, the magnitude of the bias voltage to be provided to the current source transistor CS3 may be controlled by the bias control signals B[0] and B[1], and thus, the magnitude of the driving current to be provided to the micro-LED LED may be controlled. Accordingly, driving currents of different magnitudes may be provided to the micro-LED LED without using a plurality of current source transistors within a pixel.

Referring to FIG. 8, the remaining transistors other than the current source transistor CS3 are capable of being implemented to operate at a low operating voltage. Accordingly, like the embodiment of FIG. 6, as the remaining components of the pixel driving circuit are separated from the micro-LED by using the current source transistor CS3, only the current source transistor CS3 may be implemented by using a transistor operating at a high operating voltage, and the remaining components other than the current source transistor CS3 may be implemented by using a transistor operating at a low operating voltage. That is, in the driving circuit 130B, the remaining elements other than the current source transistor CS3 providing the driving current to the micro-LED LED may operate at a low operating voltage. For example, transistors constituting the selection circuit 133B and the control memory devices 131B and 132B controlling the selection circuit 133B may also operate at a low operating voltage.

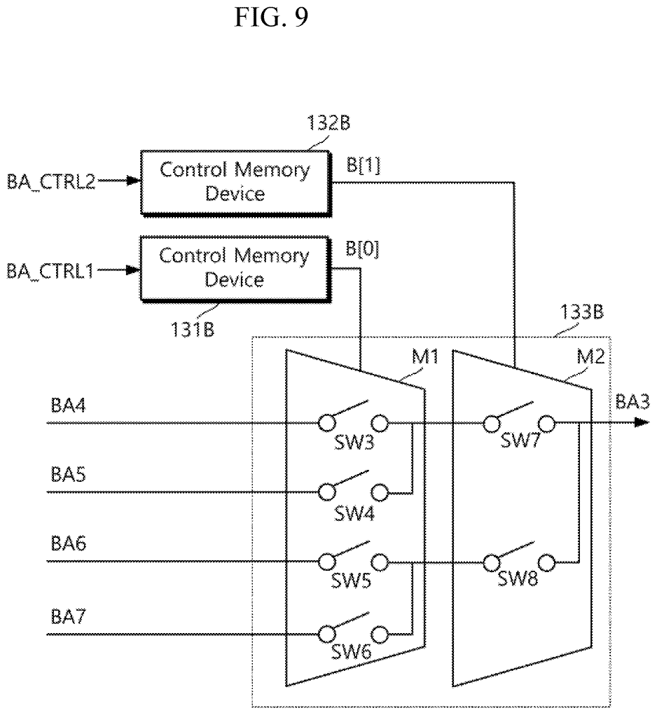

FIG. 9 is a diagram describing the selection circuit 133B of the driving circuit 130B according to the embodiment of FIG. 8.

The selection circuit 133B may include a plurality of multiplexers M1 and M2. Each of the plurality of multiplexers M1 and M2 may include a plurality of switches.

For example, the first multiplexer M1 may include a plurality of switches SW3, SW4, SW5, and SW6 which connect input terminals respectively receiving the plurality of bias voltages BA4, BA5, BA6, and BA7 to two output terminals. The second multiplexer M2 may include a plurality of switches SW7 and SW8 which connect input terminals respectively receiving outputs of the first multiplexer M1 to one output terminal.

The first multiplexer M1 may output two bias voltages among the plurality of bias voltages BA4, BA5, BA6, and BA7 based on the first bias control signal B[0], and the second multiplexer M2 may output, as the bias voltage BA3, one of the two bias voltages output from the first multiplexer M1 based on the second bias control signal B[1].

Because the plurality of multiplexers M1 and M2 control the current magnitude in an analog manner through the gate node of the current source transistor CS3 of FIG. 8, the plurality of multiplexers M1 and M2 may be implemented by using elements operating at a low operating voltage.

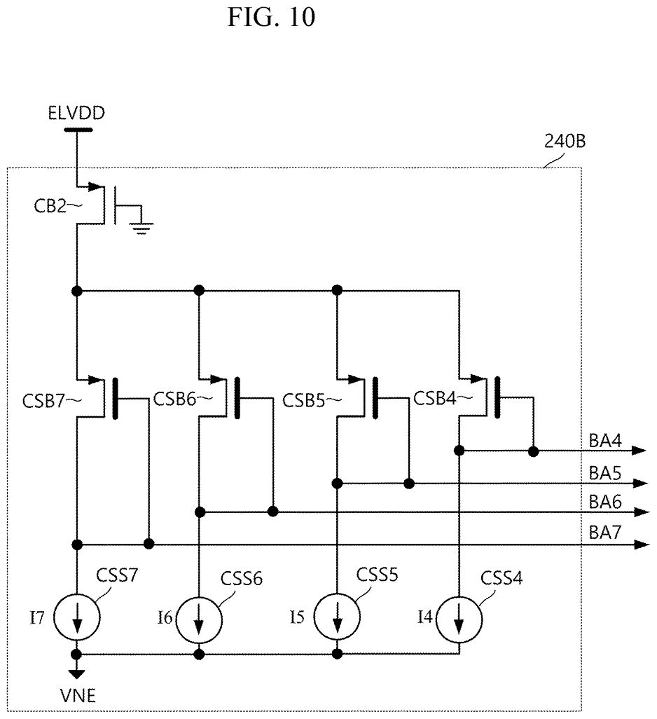

FIG. 10 is a diagram describing a bias circuit according to one or more embodiments of the present disclosure. A bias circuit of FIG. 10 may correspond to the bias circuit 240 of FIG. 1. The description which is the same as the description given based on the embodiment of FIG. 7 will be omitted to avoid redundancy. A difference between the embodiment of FIG. 7 and the embodiment of FIG. 10 will be mainly described.

The bias circuit 240B of FIG. 10 may constitute a current mirror circuit with the current source transistor CS3 and the control transistor 120 of the pixel driving circuit 130B of FIG. 8. Each transistor of the bias circuit 240B may operate as a reference transistor, and each of the current source transistor CS3 and the control transistor 120 of the pixel driving circuit 130B of FIG. 8 may operate as a mirror transistor.

For example, a transistor CB2 of the bias circuit 240B may have the same aspect ratio as the control transistor 120. Each of a plurality of bias transistors CSB4, CSB5, CSB6, and CSB7 may have the same aspect ratio as the current source transistor CS3. Each of the plurality of bias transistors CSB4, CSB5, CSB6, and CSB7 may be configured to operate at a high operating voltage.

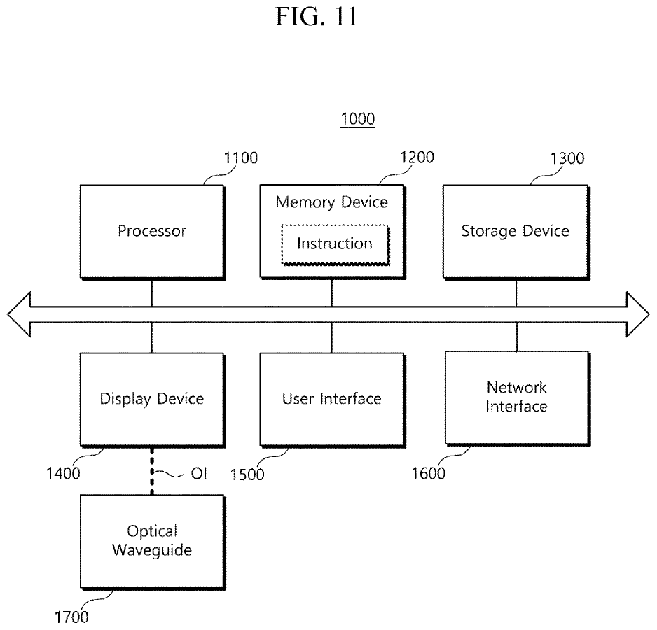

FIG. 11 is a block diagram describing a configuration of an electronic device 1000 according to one or more embodiments of the present disclosure.

The electronic device 1000 may include a processor 1100, a memory device 1200, a storage device 1300, a display device 1400, a user interface 1500, and a network interface 1600.

The processor 1100 may control the electronic device 1000 by using at least one instruction which is loaded into the memory device 1200 and is temporarily stored therein. The processor 1100 may transmit image data stored in the storage device 1300 or image data received from any other peripheral device (e.g., a camera device) to the display device 1400. The processor 1100 may control the display device 1400 such that the image data are displayed on the display device 1400.

In an embodiment, the display device 1400 may include an optical waveguide 1700 configured to guide a light signal of a micro-LED of a pixel into a preset display region. The optical waveguide 1700 may receive the light signal based on the emission of the micro-LED and may guide the light signal into the preset display region.

For example, the optical waveguide 1700 may be made of a glass or polymer forming the grating structure, and the optical waveguide 1700 may include a waveguide structure using the grating structure. The optical waveguide 1700 may be implemented by using various well-known optical waveguide structures, and the optical waveguide 1700 according to an embodiment of the present disclosure is not limited to the optical waveguide structure.

In an embodiment, the preset display region may be a display region of a see-through display device. The see-through display device may be a display device which projects a digital image or information simultaneously while the user directly views an external environment of the screen.

The display device 1400 may be connected to the optical waveguide 1700 through an optical interface OI.

For example, the optical interface OI may include various optical elements, which refract, reflect, and decompose an optical signal, such as a lens, a beam splitter, and a mirror. The optical interface OI may be implemented by using various well-known optical elements, and the optical interface OI according to an embodiment of the present disclosure does not limit optical elements to be used therein.

The processor 1100 may temporarily store a user input received through the user interface 1500 in the memory device 1200.

The processor 1100 may include an artificial intelligence-based accelerator which accelerates the deep learning or machine learning computation. The accelerator may include a graphic processing unit (GPU), a tensor processor, a neural processing unit (NPU), or a digital signal processor (DSP).

The memory device 1200 may temporarily store codes for the operation of the electronic device 1000, data for the operation of the processor 1100, etc. The memory device 1200 may include a dynamic random access memory (DRAM) and/or an SRAM.

The storage device 1300 may store the image data. The storage device 1300 may store a trained learning model. The learning model may be an on-device learning model. For example, the learning model may be a lightweight learning model which allows the electronic device 1000 to perform an inference operation. The learning model may be implemented by hardware, software, or a combination of hardware and software, and when some or all of the learning model is implemented by software, one or more parameters and/or hyperparameters constituting the learning model may be stored in the storage device 1300.

The storage device 1300 may include a computer-readable storage medium. The storage medium includes all kinds of recording devices where data capable of being read by a computer are stored. The storage medium may include at least one of a hard disk drive (HDD), a solid state drive (SSD), a silicon disk drive (SDD), a read only memory (ROM), a CD-ROM, a magnetic tape, a floppy disk, and an optical data storage device. The storage medium may include a nonvolatile memory device. For example, the storage medium may include different kinds of nonvolatile memories such as a NAND flash memory, a vertical NAND (V-NAND) flash memory, a NOR flash memory, a magnetic RAM (MRAM), a phase-change RAM (PRAM), a ferroelectric random access memory (FRAM), a spin transfer torque random access memory (STT-RAM), and/or a resistive RAM (RRAM).

The electronic device 1000 may communicate with the external device through the network interface 1600.

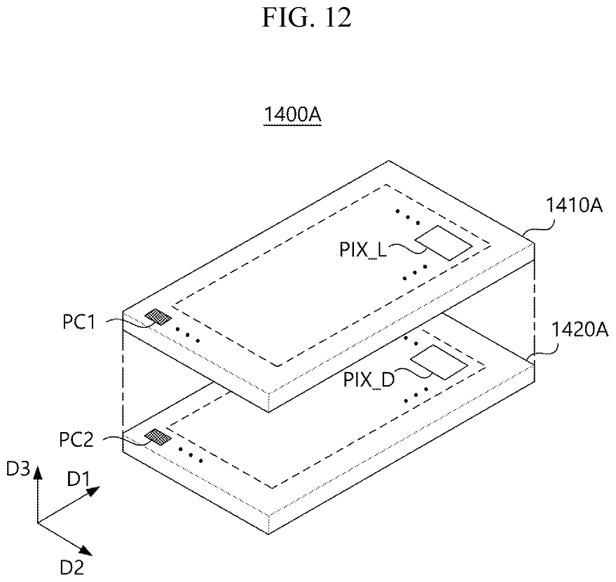

FIG. 12 is a diagram describing a display device 1400A according to one or more embodiments of the present disclosure. The display device 1400A of FIG. 12 may correspond to the display device 10 of FIG. 1 and the display device 1400 of FIG. 11.

A pixel of the display device 1400A may be implemented on a substrate in a semiconductor-stacked structure.

Referring to FIG. 12, the display device 1400A may include a first substrate 1410A and a second substrate 1420B. The first substrate 1410A and the second substrate 1420B may be stacked sequentially in a direction D3 perpendicular to a plane (surface parallel to D1 and D2) of a substrate.

In an embodiment, at least some components of a pixel circuit PIX_D may be implemented in a substrate different from that of a light emitting element PIX_L.

For example, the light emitting element PIX_L of each pixel may be formed in the first substrate 1410A, and at least a portion of the pixel circuit PIX_D electrically connected to the light emitting element PIX_L may be formed in the second substrate 1420A. For example, at least one of the control circuit, the driving circuit, and the control transistor according to the embodiments described with reference to FIGS. 1 to 10 may be located in the second substrate 1420A different from the first substrate 1410A where the light emitting element PIX_L is located.

The shape where some of pixel circuits are disposed in the first substrate 1410A and the second substrate 1420B is not limited thereto.

The first substrate 1410A and the second substrate 1420A may be electrically connected to each other.

In an embodiment, the first substrate 1410A and the second substrate 1420A may be connected by using a hybrid copper bonding manner. The light emitting element and the pixel circuit may exchange electrical signals through the hybrid copper bonding.

A micro-LED pixel according to an embodiment of the present disclosure, a display device including the micro-LED pixel, and an electronic device including the same may improve the degree of integration of the pixel.

A micro-LED pixel according to an embodiment of the present disclosure, a display device including the micro-LED pixel, and an electronic device including the same may reduce the active area of the micro-LED pixel.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a pixel array including a plurality of pixels; and
a bias circuit configured to transmit a plurality of bias voltages to each of the plurality of pixels,
wherein each of the plurality of pixels includes:
a micro-light emitting diode (LED) configured to receive a driving current;
a driving circuit including at least one current source transistor configured to provide the driving current to the micro-LED based on the plurality of bias voltages;
a control circuit including a plurality of memory devices, and configured to output a pulse width modulation (PWM) signal; and
a control transistor configured to provide a supply voltage to the driving circuit based on the PWM signal input to a gate terminal of the control transistor.

2. The display device of claim 1, wherein the plurality of memory devices are configured to store data, and
wherein the control circuit is configured to output the PWM signal based on the stored data.

3. The display device of claim 1, wherein the driving circuit is configured to receive the plurality of bias voltages and to provide the driving current based on at least one bias voltage among the plurality of bias voltages.

4. The display device of claim 1, wherein the driving circuit includes the at least one current source transistor receiving any one bias voltage among the plurality of bias voltages,
wherein the control transistor is configured to operate at a first operating voltage, and
wherein the at least one current source transistor is configured to operate at a second operating voltage greater than the first operating voltage.

5. The display device of claim 1, wherein the plurality of memory devices include at least one of a latch, a flip-flop, and a static random access memory (SRAM).

6. The display device of claim 1, wherein the driving circuit is configured to provide at least one of a plurality of driving currents to the micro-LED, based on the plurality of bias voltages.

7. The display device of claim 1, wherein the driving circuit includes:
a plurality of current paths configured to connect the control transistor to the micro-LED;
a plurality of switches disposed on the plurality of current paths, respectively; and
a plurality of switch control memory devices configured to control the plurality of switches, respectively.

8. The display device of claim 1, wherein the driving circuit includes:
a first current source transistor configured to receive a first bias voltage among the plurality of bias voltages through a gate terminal of the first current source transistor and to output a first driving current based on the first bias voltage;
a second current source transistor configured to receive a second bias voltage among the plurality of bias voltages through a gate terminal of the second current source transistor and to output a second driving current based on the second bias voltage;
a first switch configured to connect the control transistor to the first current source transistor;
a second switch configured to connect the control transistor to the second current source transistor;
a first memory device configured to transmit a first control signal to the first switch; and
a second memory device configured to transmit a second control signal to the second switch.

9. The display device of claim 8, wherein the first bias voltage and the second bias voltage are substantially equal to each other or are different from each other.

10. The display device of claim 8, wherein the first control signal and the second control signal are configured to selectively turn on both the first switch and the second switch or to turn on only one of the first switch and the second switch.

11. The display device of claim 1, wherein the driving circuit includes:
a selection circuit configured to select any one bias voltage among the plurality of bias voltages;
at least one control memory device configured to control the selection circuit; and
a first current source transistor configured to receive the any one bias voltage from the selection circuit through a gate terminal of the first current source transistor, to receive the supply voltage through a first terminal of the first current source transistor, and to output the driving current through a second terminal of the first current source transistor.

12. The display device of claim 11, wherein the plurality of bias voltages have different magnitudes.

13. The display device of claim 1, wherein the bias circuit includes:
a plurality of bias transistors, each of which includes a source terminal, a drain terminal, and a gate terminal connected to any one of the source terminal and the drain terminal, wherein the gate terminal is connected to any one of bias voltage output nodes; and
a plurality of constant current sources respectively connected to the plurality of bias transistors.

14. The display device of claim 13, wherein the bias circuit is configured to constitute a current mirror circuit with the at least one current source transistor of the driving circuit and the control transistor.

15. The display device of claim 13, wherein the pixel array includes a first pixel and a second pixel located in a same row, and
wherein the first pixel and the second pixel are connected to a plurality of lines transferring a plurality of bias voltages output from the bias circuit.

16. A pixel comprising:
a micro-LED configured to receive a driving current;
a driving circuit including at least one current source transistor configured to provide the driving current to the micro-LED based on a plurality of bias voltages;
a control circuit including a plurality of memory devices, and configured to output a PWM signal; and
a control transistor configured to provide a supply voltage to the driving circuit based on the PWM signal input to a gate terminal of the control transistor.

17. The pixel of claim 16, wherein the driving circuit is connected to lines transferring the plurality of bias voltages from a bias circuit located outside the pixel.

18. The pixel of claim 16, wherein the driving circuit includes at least one current source transistor receiving any one bias voltage among the plurality of bias voltages,
wherein the control transistor is configured to operate at a first operating voltage, and
wherein the at least one current source transistor is configured to operate at a second operating voltage greater than the first operating voltage.

19. An electronic device comprising:
a display device including a pixel array in which a plurality of pixels are arranged; and
a processor configured to transmit image data to the display device and to control the display device,
wherein each of the plurality of pixels includes:
a micro-LED configured to receive a driving current;
a driving circuit including at least one current source transistor configured to provide the driving current to the micro-LED based on a plurality of bias voltages;
a control circuit including a plurality of memory devices, and configured to output a pulse width modulation (PWM) signal; and
a control transistor configured to provide a supply voltage to the driving circuit based on the PWM signal input to a gate terminal of the control transistor.

20. The electronic device of claim 19, further comprising:
an optical waveguide configured to receive a light signal of the micro-LED, which is based on the image data, and to guide the light signal to a preset display region.
